(19) United States
(12) Patent Application Publication
(10) Pub. No.: US 2004/0247978 A1
(43) Pub. Date: Dec. 9, 2004

(54) Bipolar plate for fuel cell and method for production thereof

(76) Inventor: Takayuki Shimamune, Tokyo (JP)

Correspondence Address: YOUNG & THOMPSON, 745 SOUTH 23RD STREET, 2ND FLOOR, ARLINGTON, VA, 22202, US

(21) Appl. No.: 10/489,963

(22) PCT Filed: Sep. 11, 2002
(86) PCT No.: PCT/JP02/09307

(30) Foreign Application Priority Data
Sep. 18, 2001 (JP) 2001-283319
Sep. 18, 2001 (JP) 2001-283320
Dec. 7, 2001 (JP) 2001-374187
Dec. 7, 2001 (JP) 2001-374188
Dec. 7, 2001 (JP) 2001-374738

(51) Int. Cl. H01M 8/02; B05D 5/12; C25B 11/00; B32B 15/04; B32B 15/00

(52) U.S. Cl. 429/34; 427/115; 427/123; 427/126.3; 204/282; 428/670; 428/680; 428/685; 428/469

(57) ABSTRACT

In a bipolar plate for a fuel cell including a metal substrate and a metallic coating formed on at least part of a surface of the metal substrate, the durability or the resilience is elevated by suitably selecting a material or a shape of the metal substrate and/or the metallic coating. The material of the metal substrate includes one or more of metals or metal alloys selected from a group consisting of iron, nickel, alloys thereof and stainless steel; and the metallic coating includes a combination of conductive platinum-group metal oxides. The metal substrate may be a thermally oxidized substrate, and the metallic coating may be a conductive oxide. Further, the metallic coating may be a metallic porous element or a metallic porous element having a passivity prevention layer on the surface thereof.

### TECHNICAL FIELD

The present invention relates to a bipolar plate of a fuel cell, especially a solid polymer electrolyte fuel cell and a method for manufacturing the same, more specifically to a metal bipolar plate of which a surface is treated, and further to an inexpensive and higher-stable bipolar plate of a fuel cell having a valve metal substrate whose surface is processed for increasing the anti-corrosion and electric conductivity. The present invention provides, as another embodiment, a bipolar plate for a fuel cell made of metal having elasticity or a resilience, and more specifically to a bipolar plate for a fuel cell manufactured by forming a porous silver coating on the surface of a metal substrate. The present invention provides, as a further embodiment, a bipolar plate for a fuel cell with a resilience made of stable metal and retaining (keeping) good electric conductivity also under cathodic polarization. The present invention further provides an Membrane-Electrode Assembly (MEA) usable in an electrochemical devices such as a fuel cell and an electrolytic apparatus, a method of manufacturing the same, and the fuel cell and the electrolytic apparatus having the MEA.

### BACKGROUND ART

A fuel cell that is the ultimate power generation technology with cleanness and a higher efficiency is attracting the utmost attention as the maximal and practical technology in near future. Recently, with the progress of materials, especially, of the ion exchange membrane technology, a solid polymer electrolyte fuel cell operating at an ordinary temperature has been becoming popular. As its application, the real practical use of a fuel cell-powered vehicle and on-site generation systems such as a small-sized cogeneration system for family use are recognized to be one of the most important technologies. The continuous research and development have been focused on the technologies used in the fuel cell such as an ion exchange membrane substantially acting as an electrolyte and electrode materials used in a cathode and an anode so that the technical levels of these technologies are approaching to the ultimate situation.

On the other hand, as the fuel cell-related technology which is important but to which no technical solution is proposed, there arises a problem in connection with a fuel cell main body, especially a separator between the cells connected in series, or a bipolar plate. A satisfactory solution is not provided when the cost is included, although this problem has been extensively investigated. Currently the bipolar plate made of the carbon-based material used in the conventional fuel cell technology is mainly applied.

While one surface of the fuel cell facing to the cell is exposed to a reductive hydrogen gas atmosphere, another surface is exposed to an oxidative oxygen atmosphere. The fuel cell used in these severe conditions and further in humid conditions is likely to be suffered by the accelerated corrosion so that an ordinary metal is hardly used as the bipolar plate.

Regardless of the materials to be used, the bipolar plate is desirably in contact with the entire electrode surface with a uniform pressure. A precision processing is required such as the formation of gas passages and liquid passages though depending on the circumstances. The carbon-based material frequently used in the conventional fuel cell is easily processable though it is not so good at its mechanical strength. Since the processing is required to be extremely precise even if the easily processable carbon-based material is used, the material cost of the bipolar plate including its process cost is highest among those of the components of the fuel cell.

The carbon-based material having less conductivity than the metals consumes the generated power to cause a problem of decrease of energy efficiency in addition to the insufficient power generating ability.

In order to solve these problems in connection with the carbon-based material, a bipolar plate made of a metal is developed. Such an up-to-date bipolar plate was reported in a debriefing session with regard to solid polymer electrolyte fuel cells held by NEDO (New Energy and Industrial Technology Developing Organization of METI. Japan.) in 2001. In the debriefing session, Aisin Seiki Co., Ltd. proposed a bipolar plate formed by plating gold on the surface of stainless steel, and indicated that the humid section was likely to be corroded and the cost of the bipolar plate was high. Hitachi, Ltd. proposed a bipolar plate formed by applying graphite-based paint on the surface of stainless steel, and indicated the increase of the electric resistance due to the paint even if the cost of the bipolar plate was reduced. Further, while Sumitomo Metal Industries, Ltd. reported a process of stably keeping current by dispersing a metal capable of always holding conductivity in stainless steel and by forming an oxide film on the surface of the stainless steel, the process is liable to require the higher cost unless it is mass-produced.

Mitsubishi Electric Corporation proposes use of a carbon mold made of a conventional carbon-based material, and the problem of the conventional carbon-based material or the lack of the mechanical strength is not yet solved.

The bipolar plate of Ballard Power Systems, Inc. of Canada recognized to be most practical in these days intends the cost reducing by producing the near net shape processing on the carbon substrate. However, from a practical standpoint, the near net shape processing of the carbon itself is not clearly reported, and it is unclear that the disadvantages such as the weakness of the above mechanical strength, especially the weakness against bending and the insufficient electric conductivity can be improved or not.

In order to elevate the performance, the fuel cell desirably has a surface area to some extent that is must have larger dimensions. Unless electrodes and current collectors are in contact with each other at the nearly same pressure on the entire surfaces of the electrodes having the larger dimensions so that the uniform current can not be obtained to the entire surface of the electrode, the efficiency is significantly reduced so that the effects given by using the large-dimension electrode cannot be obtained. While a membrane electrode assembly (MEA) itself may be assumed to be an ion exchange membrane as a whole, the entire surface of the electrode is required to be in contact with the current collector at the substantially same pressure for absorbing the thickness fluctuation and realizing the uniform pressure. However, as described, the MEA, the current collector and the bipolar plate, generally have no or little elasticity. Accordingly, if the parallelism among the respective elements or the thickness thereof changes even partially, the contact between the MEA and the current collector comes to be insufficient, thereby generating the current deviation, and this trend is remarkable in the larger-sized fuel cell.

In almost all the conventional fuel cells, the uniform current is realized by performing special finishing to all the components with higher accuracy than those ordinarily required for preventing the current deviation by means of elevating the parallelism among the respective units. However, its procedures arise problems that an extremely higher cost is required and a mass-production ability grows worse. For overcoming the problems, the electrodes are miniaturized. As described, in almost all the prior arts, both of the current collector and the bipolar plate are so rigid that the contact with the electrode surface cannot be adjusted.

U.S. Pat. Nos. 5,482,729, 5,565,072 and 5,578,388 disclose, as the other up-to-date technology for responding to these problems, a metal bipolar plate in which a mesh is attached on part of the metal surface and the remaining surface is covered with metal oxide in advance for increasing the durability and for obtaining the conductivity through the mesh. Although the structure is effective for obtaining the durability and the conductivity, other problems arise that the structure is complicated and the cost cannot be reduced.

As described above, the ion exchange membrane substantially used as the electrolyte in the fuel cell or the electrolyzer is the main component thereof, and the electric resistance of the ion exchange membrane is relatively large. Accordingly, the following problems may be caused. When a current density is increased in case of a higher electric resistance in the fuel cell, generating voltage is remarkably reduced. In case of the electrolyzer, the higher electric resistance increases the electrolytic voltage so that the superfluous power is required and the larger heat is generated.

In order to reduce the electric resistance of the ion exchange membrane, the reduction of the thickness of the ion exchange membrane itself is endeavored. In the fluorocarbon resin-based perfluorocarbon sulfonic acid ion exchange membrane, the ion exchange membrane having thickness of 50 microns is currently trialed in place of the conventional thickness of about 100 microns, and further the ion exchange membrane having thickness of 25 microns is manufactured by way of trial.

In this manner, the electric resistance of the ion exchange membrane decreases with the reduction of the thickness thereof, and the reduction of the thickness reduces the physical strength of the ion exchange membrane itself, thereby producing a new problem of the difficulty of the handling.

In the solid polymer electrolyte fuel cell (PEMFC, Proton Exchange Membrane Fuel Cell), it is important to increase the energy efficiency by increasing a power generation amount so that the reduction of the resistance by the ion exchange membrane is the most important problem. In order to solve the problem, the ion exchange membrane is effectively made thinner for reducing the resistance.

In the ordinary MEA in which the electrodes are sequentially formed on the surface of the ion exchange membrane, the higher strength possessed by the ion exchange membrane is the major prerequisite. Accordingly, the higher membrane strength is secured by sacrificing the reduction of the electric resistance.

In order that the mechanical strength is secured while the possibility of reducing the electric resistance to one quarter is examined, that is reducing the membrane thickness of 100 microns to 25 microns, a reinforcing element is embedded in the ion exchange membrane though the electric resistance increases under the current circumstances. A membrane having pores originally filled with ion exchange resin acting as the reinforcing element is also developed. As a result of the development, though the reinforcing element is made of the sufficiently thin and strong material, the inevitable increase of the electric resistance becomes prominent with the thinning of the ion exchange membrane due to the non-flowing of current through the reinforcing element. The latest thin ion exchange membrane having the reinforcing element has the electric resistance substantially the same as that of an ion exchange membrane without the reinforcing element having thickness of 100 microns or slightly less than 100 microns. The entire performance of the Ion exchange membrane (IEM) is insufficient, although the reinforcing element in the IEM is effective to the physical strength.

When the ion exchange membrane is applied as a solid electrolyte to a fuel cell, it is sufficient to act as supporting electrolyte and the ion-selectivity is not required. Accordingly, the membrane with less electric resistance is preferable and the increase of the exchange capacity is desirable. However, the increase of the exchange capacity reduces the membrane strength so that the moderate increase of the exchange capacity is appropriate.

Because of these reasons, though the ion exchange membrane acting as the solid electrolyte has the sufficiently low electric resistance, the membrane cannot be put to the practical use in reality.

The fuel electrode (anode) side of the ion exchange membrane used in the solid polymer electrolyte fuel cell is required to be humid for keeping wet the interior of the membrane. When the ion exchange membrane is sufficiently thin enough, the wet condition can be held with moisture (water) generated at the counter electrode even if supply gas does not contain moisture. In spite of the meaningfulness of the thinner ion exchange membrane in view of the above standpoint, the demand with respect to the mechanical strength restricts the thinning of the ion exchange membrane.

As described, the bipolar plate and the ion exchange membrane applied in the conventional fuel cell include unsatisfactory performances.

### DISCLOSURE OF INVENTION

A subject of the present invention is to solve the above-mentioned problems of the prior art, and an object of the present invention is to provide a bipolar plate for a fuel cell with a relatively lower cost which includes a simpler structure, better processability, durability and conductivity and a method of manufacturing the same; a bipolar plate easily processed and suitable for mass-production in which a relatively uniform current density is obtained on the entire surface of an electrode and a method of manufacturing the same; a bipolar plate for a fuel cell in which a relatively uniform current density is obtained on the entire surface of the electrode and in which a stable operation can be conducted for a relatively longer period of time even when used in a cathodically polarized condition and a method of manufacturing the same; and a membrane electrode assembly (MEA) which achieves the thinning of the ion exchange membrane in the MEA with little reducing the mechanical strength thereof and a method of manufacturing the same.

The present invention covers firstly a bipolar plate for a fuel cell comprising of a metal substrates made of one or more metals or metal alloys selected from a group of iron, nickel, alloys thereof and stainless steel and a coating comprising of a conductive platinum-group metal oxide, formed on at least a part of a surface of the metal substrate (hereinafter referred to as “first invention”); secondly a bipolar plate for a fuel cell having thermally oxidized metal substrate and a metallic coating made of an electrically conductive oxide formed on at least part of a surface of the metal substrate (hereinafter referred to as “second invention”), thirdly a bipolar plate for a fuel cell having metal substrate and a metallic coating including a porous metallic material and formed on at least part of the metal substrate (hereinafter referred to as “third invention”), and fourthly a membrane-electrode assembly including an ion exchange membrane, an cathode and an anode intimately attached to the ion exchange membrane, in which at least one of the cathode and the anode having good rigidity (hereinafter referred to as “fourth invention”).

The bipolar plates for the fuel cell and the electrode-ion exchange membrane assembly (MEA) in accordance with the first to fourth inventions are manufactured under any suitable processes.

The bipolar plate for the fuel cell of the first invention using a metal substrate gives better rigidity than a conventional substrate made of a carbon-based material, and also gives less deformation and in other words, the mechanical strength thereof is larger. Even if the plate is deformed, it is easily adjusted.

The processability of the metal substrates is excellent with its larger mechanical strength and gas passages and bolt holes which are required for the bipolar plate can be easily formed. The excellent processability gives advantages in the mass production, and enables the significant cost reducing.

The electrically conductive oxide coating of the platinum-group metal formed on the surface of the metal substrate has the excellent conductivity, and prevents the passivation almost perfect during the operation as a fuel cell, thereby securing the conductivity to enable the continuous operation for a longer period of time.

When a platinum metal is present together with the conductive oxide coating of the platinum-group metal on the surface of the metal substrate, the platinum acting as good catalyst covers the surface of the metal substrate made of the stainless steel including the portion on which no platinum-group metal exists.

In this manner, the bipolar plate for the fuel cell of the first invention can operate while maintaining the power generation efficiency higher by reducing the ohmic loss without arising a problem of corrosion for a longer period of time.

Also the bipolar plate for the fuel cell of the second invention is rigid and less deformed, and the mechanical strength thereof is larger. Even if the plate is deformed, it is easily adjusted because the metal substrate similarly to that of the first invention is used.

The electrically conductive oxide coating such as titanium oxide formed on the metal substrate surface prevents the passivation almost perfectly to keep the conductivity.

Further, since the metal substrate before the formation of the conductive oxide coating is thermally oxidized such that the surface thereof is converted into the oxide, the adhesiveness between the conductive titanium oxide thermally formed and the metal substrate is elevated to improve the corrosion resistance, and the oxide formed by means of the thermal oxidation protects the metal substrate to elongate its life.

In this manner, the bipolar plate for the fuel cell of the second invention can operate while maintaining the power generation efficiency higher by reducing the ohmic loss without suffering a problem of corrosion for a longer period of time.

The bipolar plate for the fuel cell of the third invention has the metallic porous element being formed on the metal substrate, and the metallic porous element has elasticity and can be deformed. Accordingly, the lack of the adhesion between the electrode and the ion exchange membrane or the current collector is prevented which is a big problem accompanied with the fabrication of the large scale fuel cell required for high performance of the fuel cell, especially, for securing the higher power generation capacity. That is, even if the unevenness of the ion exchange membrane exists by the contact between the metal substrate and the ion exchange membrane in the fuel cell, the metallic porous element on the metal substrate surface is deformed to absorb the unevenness to achieve the substantially uniform contact between the metal substrate and the ion exchange membrane so that the current can be taken out at the maximum efficiency. Also when a plurality of fuel cell units are stacked, the deformation of the porous element absorbs the thickness fluctuation at the stacked position.

The metallic porous element is desirably made of silver, and the characteristics of the silver such as the easily-conducted sintering and the excellent elasticity and conductivity can be performed at the maximum.

When the silver is hardly sintered with the other metals for integration, the bipolar plate for the fuel cell with the excellent mechanical strength can be provided by forming the silver porous element on the plated silver, prior formed on the surface of the metal substrate and the porous element is adhered at the higher strength.

The porous element is preferably formed by application of metal-containing paste followed by sintering, and can be formed, in addition thereto, by coating of the metallic porous element by means of an adhesive agent or thermal decomposition process of silver and gas bubbling agent.

In the third invention, a carbon-based substrate can be used in place of the metal substrate, and the metallic porous element to be coated supplements the difficulty in connection with the flat-surface processing possessed by the carbon-based substrate.

A layer eliminating passivation can be formed on the surface of the metallic porous element as one embodiment of the third invention. While the fuel cell is frequently used under such a severe condition that anodic polarization and cathodic polarization are repeated, the passivation preventing layer formed on the surface of the metallic porous element protects the underlying porous element to prevent the conversion of the porous element into the non-conductive oxide in the bipolar plate for the fuel cell of the present embodiment, in addition to the functions of the above-described metallic porous element. Accordingly, the excellent conduction is maintained even after the use for a longer period of time, thereby retaining the higher power generation capacity.

Since the mechanical strength of the whole MEA is charged to a cathode and/or an anode and is not substantially charged to the ion exchange membrane in the MEA of the fourth invention, the thickness of the ion exchange membrane can be decreased. No need to considering the reduction of the mechanical strength is required and the ion exchange membrane can achieve the tremendous decrease of the electric resistance.

The MEA desirably is composed of one rigid electrode and the other elastic electrode. When both of the electrodes are rigid, the respective electrodes are not in good contact with the ion exchange membrane and to result the inhomogeneous current distribution. When one electrode is rigid and the other is elastic, the elastic electrode presses the ion exchange membrane with deformation toward the rigid electrode, thereby improving the contact between the ion exchange membrane and the electrodes.

In the MEA of the fourth invention, the reinforcing element used in the conventional ion exchange membrane is unnecessary because the thickness of the ion exchange membrane can be made thinner without considering the reduction of the mechanical strength. No or little mechanical strength is required in the ion exchange membrane of the MEA so that the ion exchange membrane is not required to be solidified at the time of the assembly, and the ion exchange membrane can be fabricated by using fluid ion exchange resin.

The MEA of the fourth invention is preferably applied to a solid polymer electrolyte fuel cell or a zero gap electrolyzer.

The above and the other objects, embodiments and advantages of the present invention will be apparent in accordance with the following description.

### BRIEF DESCRIPTION OF DRAWINGS

FIG. 1 is a horizontal sectional view exemplifying a fuel cell having a bipolar plate and an MEA in accordance with the present invention.

### BEST MODE FOR IMPLEMENTING INVENTION

The first to fourth inventions will be fully described in sequence.

[First Invention]

The first invention is the bipolar plate for the fuel cell which fundamentally solves the problems of the corrosion resistance and the processability by using valve metal as the substrate of the bipolar plate for the fuel cell and further solves the problem of the deficiency with respect to the current flowing due to the surface oxidation after the use for a longer period of time by means of forming the conductive oxide coating made of the platinum-group metal on the surface.

The bipolar plate for the fuel cell of the first invention is manufactured as follows.

The metal substrate of the bipolar plate for the fuel cell in accordance with the first invention is made of the so-called valve metal such as titanium, niobium, iron, nickel, alloys thereof and stainless steel; and among these, the stainless steel is desirably employed. The kinds thereof are not especially restricted, and SUS 304 and SUS 316 having the excellent corrosion resistance are effectively used.

The valve metal has a function of preventing surface corrosion by forming an oxide insulator on its surface in an oxidative atmosphere such as an anodic polarization. The valve metal cannot perform its function by itself as the bipolar plate for the fuel cell because of its insufficient conductivity though it is chemically stable. Accordingly, in the first invention, the conductive platinum-group metal oxide coating is formed on the surface of the metal substrate as described later.

Machining such as formation of passages of supplying and discharging gas or liquid to and from the fuel cell and of bolt holes for assembly is performed by means of pressing on the metal substrate made of the valve metal depending on necessity. The machining may be unnecessary depending on the structure of the fuel cell.

Then, the metal surface receives the treatment such as washing, degreasing and pickling for cleaning up the surface, and the surface is activated by means of blasting or the like depending on a purpose. Purposes of these treatments are the increasing of the corrosion resistance on the metal substrate surface and the prevention of the passivation during the use.

The washing is conducted for removing impurities adhered on the metal substrate surface by using, for example, a neutral detergent or an organic solvent for conducting the degreasing. Although the metal substrate can be thermally treated at this moment, an undesirable oxide may be generated on the surface thereof after high-temperature heating so that the heating is preferably conducted at a relatively lower temperature.

Pickling can be conducted under ordinary conditions, and a desirable solution therefor is hydrochloric acid or mixed acid containing hydrofluoric acid and nitric acid. The pickling is conducted by, for example, dipping the metal substrate in 20% by weight hydrochloric acid at 60° C. for about 5 to 10 minutes. A process can be used in which an pickling solution containing, for example, 5% by weight HF and 25% by weight HNO₃ used in the ordinary etching process using the mixed acid containing hydrofluoric acid and nitric acid can be showered onto the metal substrate at room temperature. Although sulfuric acid or nitric acid can be used for the pickling, these acids are undesirable except for special occasions because these acids are oxidative and possibly form an oxidation film on the surface.

Then, the platinum-group metal oxide coating is formed on the metal substrate surface. The platinum-group metal oxide coating may be a specified single platinum-group metal and desirably includes platinum. The coating may contain a small amount of other metal oxides such as titanium oxide with or without the platinum. The most desirable combination of the platinum-group metals is the platinum and ruthenium, and its composition ratio is platinum:ruthenium=(20 to 50 molar %):(50 to 80 molar %). When the molar % of the ruthenium exceeds 80%, the volume expansion due to the oxidation of the ruthenium becomes conspicuous in the subsequent oxidation reaction so that the peeling-off tends to take place. When the molar % of the ruthenium is below 50% (the molar % of the platinum exceeds 50%), a larger amount of the expensive platinum is undesirably used. When the platinum-group metal oxide coating is formed by means of a substitution reaction using an application liquid or a dipping liquid as described later, the cost is not so high even the expensive platinum-group metal is used because of a required amount of the platinum-group metal is so small.

While the platinum-group metal oxide coating may be formed on the metal substrate surface by means of an evaporation process or a spray process, a substitution process or a thermal decomposition method is ordinarily employed.

In each of the methods, the coating solution or the dipping liquid solution is firstly prepared by dissolving a salt of the platinum-group metal. Examples of the platinum-group metal include platinum, palladium, ruthenium, osmium and iridium, and examples of their salts include chlorides and nitrates. The preparation of the coating solution and the dipping solutions comprising of platinum-group metal salt done by simply dissolved in water, hydrochloric acid or nitric acid with adjusting the salt concentration (converted into the metal concentration) being adjusted to be about 5 to 10 g/liter. One preferred example of the coating solution or the dipping solution is prepared by dissolving chloroplatinic acid and ruthenium chloride into about 10 to 30%, preferably about 20% of hydrochloric acid. When the hydrochloric acid concentration is below 10%, the substitution can be hardly performed because the reactivity with the metal substrate, especially, the metal substrate made of stainless steel is lowered. When the concentration is over 30%, the metal substrate may be etched such that the reaction stops at this moment after a short period of time to possibly arise a problem in connection with time regulation.

The metal substrate may be simply dipped in a platinum-group metal salt solution in the dipping method. The dipping conditions are not especially restricted, and the metal substrate may be dipped in the dipping solution at a temperature from ambient temperature to about 60° C. for a suitable period of time. Iron and nickel contained in the component metal in the metal substrate such as iron, nickel or stainless steel are eluted and substituted with the substantially same amount of the platinum-group metal in the dipping solution to be deposited onto the metal substrate surface during the above dipping. The platinum-group metal incorporated into the metal substrate by means of the substitution makes the bonding stronger to achieve a longer life because the elution hardly takes place. The end point of the substitution is frequently judged by means of color development of the dipping solution.

An application method may be applied in place of the dipping process in which the metal substrate is not dipped in the liquid for depositing the platinum-group metal salt solution thereto, but the platinum-group metal salt solution is deposited to the metal substrate by using a brush. The subsequent procedures for the substitution are substantially the same as those of the dipping method.

After the platinum-group metal is deposited onto the metal substrate surface by means of the substitution method in this manner, the thermal treatment is performed. The metal substrate is heated and oxidized, for example, at a temperature of about 350 to 600° C. Thereby, at least a part of the platinum-group metal such as ruthenium is oxidatively converted into the conductive platinum-group metal oxide. The platinum is not oxidized upon the heating, and exists as the platinum metal on the metal substrate surface.

When not all the surface of the metal substrate is covered with the platinum-group metal and a part of the metal substrate is exposed before the heating, the metal substrate surface is oxidized upon heating to be oxidatively converted into a stable oxide. Especially when the platinum is contained, the platinum acting as the excellent catalyst of oxidation and makes to cover, with the oxide, the metal substrate surface such as the stainless steel including the surface on which no platinum-group metal is present, thereby manufacturing the bipolar plate for the fuel cell.

The bipolar plate for the fuel cell of the first invention is not necessarily manufactured by using the above substitution-thermal treatment method, and may be manufactured by thermal decomposition on the metal substrate having the above-described coating solution or the dipping solution adhered to the surface thereof such that the platinum-group metal salt in the coating solution or the dipping solution is converted into the corresponding platinum-group metal oxide followed by heating.

The platinum-group metal oxide coating formed in this manner and the platinum existing depending on necessity have the excellent corrosion resistance and conductivity and are hardly passivated. The metal substrate on which the platinum-group metal oxide coating is formed is made of the valve metal which is relatively inexpensive and has the abundant processability.

Accordingly, the bipolar plate for the fuel cell of the first invention has the characteristics such as the manufacturing at the relatively lower cost, the simple structure, the abundant processabilities, the corrosion resistance and the conductivity.

[Second Invention]

The second invention is the bipolar plate for the fuel cell which fundamentally solves the problems of the corrosion resistance and the processability by using the metal substrate and further solves the problem of passivity with respect to the electric current flow due to the surface oxidation after the use for a longer period of time by means of forming the conductive oxide coating such as conductive titanium oxide on the surface.

The substrate of the bipolar plate for the fuel cell in accordance with the second invention is the metal substrate especially made of so-called valve metal such as titanium, tantalum, niobium, alloys thereof and stainless steel. The valve metal has the function of preventing the surface corrosion by forming an insulating oxide on its surface in an oxidative atmosphere such as an anodic polarization. The valve metal cannot perform its function by itself as the bipolar plate for the fuel cell because of its insufficient electric conductivity though it is chemically stable.

Accordingly, in the second invention, the electrically conductive oxide coating is formed on the surface of the metal substrate. While a metal oxide is generally insulative, the electric conductivity can be held in part of specified metal oxides and in those other than these metal oxides prepared under specified conditions.

The platinum-group metal oxide acts as such a typical conductive oxide compound. Especially, iridium oxide and ruthenium oxide have the higher conductivity, and the other platinum-group metal oxides such as palladium oxide and osmium oxide also have the conductivity. In addition thereto, part of oxides in a rutile form such as titanium oxide, tin oxide, lead oxide and manganese oxide are known as electrically conductive.

In the second invention, the use of the titanium oxide is desirable though any of these oxides may be used as the electrically conductive oxide. The several kinds of electrically conductive compounds are known as the titanium oxide. The magneli phase titanium oxide reported to be especially stable is basically the oxide in the rutile form, and the titanium oxide has oxygen lack in the rutile structure having a composition such as Ti₄O₇ and Ti₅O₉. The bulk produce of the magneli phase titanium oxide is known to be conducted by adding titanium powder acting as a reducing agent to the titanium oxide in the rutile form and by heating for a longer period of time at a temperature, for example, of 1100° C. or higher under a reducing atmosphere or in a substantial reducing atmosphere such as a higher temperature vacuum atmosphere.

The higher temperature treatment is undesirable in view of the cost and the working efficiency. The investigation of the present inventor has revealed that the titanium oxide in the rutile form can be obtained by applying a solution of titanium chloride or titanium alkoxide acting as a titanium oxide precursor to the metal substrate surface followed by thermal decomposition thereof at a relatively low temperature of 400 to 700° C. When the titanium oxide is used as the conductive oxide in the second invention, the titanium oxide in the rutile form is desirably prepared in accordance with the above process.

The bipolar plate for the fuel cell of the second invention is manufactured as follows.

The metal substrate is made of an electrically conductive metal, and the above-mentioned substrate made of the valve metal is preferable. Processing such as formation of passages of supplying and discharging gas or liquid to and from the fuel cell and of bolt holes for assembly is performed by means of pressing on the metal substrate depending on necessity. The special processing may be unnecessary, though depending on the structure of the fuel cell.

Then, the metal surface receives the treatment such as washing, degreasing and pickling for cleaning up the surface, and the surface is activated by means of blasting or the like depending on a purpose.

Then, the metal substrate surface is thermally treated. The heating conditions are given depending on the material of the metal substrate. For example, in case of the titanium and the titanium alloy on which the surface oxide can be formed relatively easily, the oxidation at 450 to 600° C. is preferable, and in case of the stainless steel on which the surface oxide is slowly formed, the oxidation at 550 to 700° C. is preferable. While the period of the heating time is not especially restricted, about 1 to 3 hours are sufficient in the above temperature range, and the heating atmosphere is generally atmospheric air. The heating can be conducted in another atmosphere and can be conducted under a lower vacuum in an extreme case. Although the rigid oxide can be formed in this case, the conductivity may be somewhat reduced. In case of attaching the importance to the conductivity, the atmospheric air or an atmosphere similar thereto is desirable.

The conductivity of these oxides is inferior to that of the metals. However, the formation of the oxides strengthens the adhesiveness of the titanium oxide coating as described later and can prevent the diffusion of hydrogen gas into the metal almost perfectly.

Then, the electrically conductive oxide, especially, the electrically conductive titanium oxide is coated on the surface of the metal substrate preferably by thermal decomposition. In case of the metal substrate made of the titanium or the titanium alloy, an alcohol or diluted hydrochloric acid solution of titanium chloride or a weakly acidic alcohol solution of titanium alkoxide such as tetrabutylorthotitanate is optimum as a titanium starting material. In case of the metal substrate made of the stainless steel, a coating solution containing less chlorine residue is desirable. If the chloride or hydrochloric acid solution is used, the chloride ion reacts with the stainless steel in the thermal decomposition step such that the component of the stainless steel is possibly mixed into the electrically conductive titanium oxide.

The solution is applied on the metal substrate surface after the thermal treatment followed by thermal decomposition. Thereby, the oxide is generated by the substitution of the chloride ion or the alkoxyl group with the oxygen. The heating may be conducted in an oxidative atmosphere at a temperature of about 400 to 600° C. While the step of the application and the thermal decomposition may be conducted once, a plurality of the applications and the thermal decompositions may be conducted for uniformly spreading the coating on the entire surface or for making the thicker coating depending on a purpose.

Although the electrically conductive titanium oxide is generated under the above thermally treating conditions, the anatase phase titanium oxide with less conductivity is often generated. In order to generate the highly conductive titanium oxide, a slight amount of ruthenium, iridium or tantalum must be added. The addition provides the conductivity by inducing the rutile form. This is probably because the oxides of the ruthenium and the iridium are the rutile form, and the oxide middle layer is converted into the same rutile layer by the ruthenium or iridium oxide acting as a nucleus

The reason of work of the tantalum is not clear but the following circumstance is observed. Heating the precursor of tantalum oxide having the composition formula such as Ta₂O₅ at a temperature of 400 to 600° C. in air provides amorphous oxide, and the X-ray diffraction peaks corresponding to crystalline phase are not obtained. When, however, mixture of the precursor of tantalum oxide mixed with that of titanium oxide is heated, the crystalline phase formed may be a good of titanium oxide, so mainly includes the titanium oxide in the rutile form probably because part of the titanium in the rutile form is replaced with the tantalum. The crystalline phases of the tantalum and the tantalum oxide are not observed, and part of these are forming solid solution or converted into amorphous tantalum oxide. When the tantalum is forming solid solution with the titanium oxide which is a reverse reaction taking place by adding the tantalum, the titanium oxide in the rutile form is supposed to be grown which is derived by the tantalum oxide taking the rutile form in the tetravalent.

The conductive oxide coating is formed on the surface of the metal substrate thermally oxidized, and the adhesiveness between the conductive oxide coating thermally decomposed, especially, the conductive titanium oxide and the metal substrate is elevated to improve the corrosion resistance because the surface of the metal substrate is converted into the oxide by means of the thermal oxidation. The oxide formed by means of the thermal oxidation protects the metal substrate to elongate its life.

In this manner, the bipolar plate for the fuel cell coated with the conductive titanium oxide is manufactured. As described before, the conductive titanium oxide is replaced with another conductive oxide by suitably selecting the starting material.

[Third Invention]

The third invention is a bipolar plate for a fuel cell in which a metallic porous element made of metal powders, especially, silver powders (porous silver) is formed on a metal substrate surface to provide resilience to the metal substrate. The elasticity deforms the porous sintered body on the metal substrate surface such that the metal substrate is in uniform contact with an ion exchange membrane to uniformize current distribution when the current collector is in contact with MEA, even if the thickness fluctuation or the unevenness is present in the MEA. Further, in case that a plurality of the single cells are stacked in series, the non-uniform current and the increase of the electric resistance can be prevented.

The porous element of the metal substrate surface may be elastically deformed to absorb the pressure when receiving the pressure, or part of the plurality of the particulate porous element may be broken to absorb the pressure.

In the ordinary fuel cell, the dimensional fluctuation of the ion exchange membrane acting as a solid electrolyte is in a range of several microns (can be absorbed by the deformation of the ion exchange membrane itself, and the respective thickness fluctuations of the current collector and bipolar plate itself are in ranges of several tens of microns, and further the fluctuation of a catalyst section is also in a range of several tens of microns at the maximum. When, accordingly, the fuel cell is assembled by using the bipolar plate of the third invention, the material and the thickness of the porous element are selected such that the fluctuations up to generally about 50 microns can be absorbed.

The material of the porous element is selected among metal materials deformable according to a pressure while maintaining conductivity. The most preferable metal is silver, and another metal such as nickel and a metal alloy can be used. In case of using the silver, the use of the metal silver elemental substance is not essential, and the porous element prepared by plating inexpensive copper particles with the silver can be used.

The silver is more easily sintered than other metals so that it can be subject to so-called loose sintering. One sintering at a lower temperature in air generally provides the desirable porous element when the silver is employed. Such loose sintering can be easily conducted at a lower cost to give higher processability. Since the silver is less expensive among the noble metals and has the excellent chemical durability, especially, the durability around the neutrality and further the extremely superior conductivity, the silver is predominant as the material of the porous element formed on the bipolar plate. In addition to the excellent ability with respect to the sintering of the silver, the metal porous element having the higher porosity can be obtained by applying and sintering silver paste containing a bubbling agent such as detergent, thereby forming bubbles. Further, a thickener such as gum xanthan may be added to provide the bipolar plate with the larger elasticity.

Then, an example of manufacturing the bipolar plate for the fuel cell of the third invention will be described.

The material of the metal substrate is not especially restricted provided that it is conductive and is processed to the required shape, and aluminum, iron (steel), nickel, alloys thereof, stainless steel, titanium and a titanium alloy can be efficiently used because they are easily available, has excellent corrosion resistance and are relatively inexpensive. The carbon substrate may also be used after the conditions are adjusted. Although the flat surface processing with the higher accuracy can be hardly conducted to the carbon substrate, the bipolar plate made of carbon and having the smooth surface can be provided when the metal porous element made of silver or the like is coated on the carbon substrate surface in accordance with the third invention because the elasticity is provided to the bipolar plate containing the carbon substrate and further the metal porous element absorbs the convexo-concave on the carbon substrate surface.

The substrate of the bipolar plate of the fuel cell in the third invention may be made of so-call valve metal such as tantalum, niobium and alloys thereof in addition to the titanium, titanium alloy and stainless steel described above. Valve metal has the function of preventing the surface corrosion by forming a stabilized oxide in a passive state on its surface in an oxidative atmosphere such as an anodic polarization. Accordingly, valve metal may not perform its function by itself as the bipolar plate for the fuel cell because of its insufficient conductivity due to the oxide in the passive state formed on the surface, though it is chemically stable.

Accordingly, when the metal substrate made of valve metal is used, a conductive oxide coating is preferably formed on the surface of the metal substrate. While a metal oxide is generally insulative, the conductivity can be held in part of specified metal oxides and in those other than these metal oxides prepared under specified conditions.

The platinum-group metal oxide acts as such a typical conductive oxide compound. Especially, iridium oxide and ruthenium oxide have the higher conductivity, and the other platinum-group metal oxides such as palladium oxide and osmium oxide also have the conductivity. These platinum-group metals electrochemically suppress the hydrogen brittleness of the valve metals to prevent the formation of the hydride of the metal on its surface, thereby realizing the stable metal substrate with a longer life. In addition thereto, part of oxides in the rutile form such as titanium oxide, tin oxide, lead oxide and manganese oxide are known to be conductive. A preferable oxide is the titanium oxide. The several kinds of conductive compounds are known as the titanium oxide. The magneli phase titanium oxide reported to be especially stable is basically the oxide in the rutile form, and the titanium oxide has oxygen deficiency generated in the rutile structure having a composition such as Ti₄O₇ and Ti₅O₉.

Machining such as formation of passages of supplying and discharging gas or liquid to and from the fuel cell and of bolt holes for assembly is performed by means of pressing on the metal substrate depending on necessity. The machining may be unnecessary depending on the structure of the fuel cell, and may be preferably performed after plating or the formation of the porous element.

Then, the metal surface is subjected to treatment such as washing, degreasing and pickling for cleaning up the surface, and the surface is activated by means of blasting or the like depending on a purpose.

Then, the metal substrate surface is thermally oxidized depending on necessity. The heating conditions are established depending on the material of the metal substrate. For example, in case of the titanium and the titanium alloy on which the surface oxide can be formed easily, the oxidation at 450 to 600° C. is preferable, and in case of the stainless steel on which the surface oxide is slowly formed, the oxidation at 550 to 700° C. is preferable. While the period of the heating time is not especially restricted, about 1 to 3 hours are sufficient in the above temperature range, and the heating atmosphere is generally atmospheric air. The heating can be conducted in another atmosphere and can be conducted under a lower vacuum in an extreme case. Although the rigid oxide can be formed in this case, the electric conductivity may be somewhat reduced. In case of requiring higher electric conductivity, the atmospheric air or an atmosphere similar thereto is desirable.

Then, a metal plated layer is formed on the metal substrate surface on which the thermal treatment has or has not been conducted, and the layer may not be formed depending on the kind of the metal substrate.

The metal plating is conducted for improving the adherability of the porous material to the metal substrate. Silver powders are preferably used for forming the porous material. Although the formation of the porous material is desirably conducted by means of sintering, the silver is hardly sintered with another metal at a temperature desirable for the silver sintering (about 250 to 450° C.). The porous material may not be bonded with the metal substrate with a sufficient adhesiveness without the above metal plating. The metal plated layer also has a function of suppressing the formation of a passivated layer easily formed on the metal substrate surface when in the use as the fuel cell. When the substrate is made of the valve metal, metal hydride formation or the hydrogen brittleness on a hydrogen electrode side is prevented by making such porous layer.

The conditions for the metal plating, especially for the silver plating, are not specifically restricted, and the metal may be plated after the metal substrate surface is cleaned and activated for forming the rigid plated layer. The plating itself is most effectively conducted by using a weakly alkaline cyanide bath ordinarily used.

Silver is hardly plated on the metal substrate surface depending on the conditions thereof. In such a case, after nickel or the like which can be plated relatively easily is plated, the silver would be plated thereon. This method is particularly effective when the metal substrate is made of titanium or titanium alloy. The conditions for the nickel plating are not specifically restricted, and normally Watt bath including nickel chloride and nickel sulfate and further a brightening agent such as glue is used for the nickel plating.

Then, the porous material is coated on the metal substrate surface on which the metal plated layer is formed or is not formed. While the porous material is preferably formed on the metal substrate surface by loosely sintered metal particles, particularly silver particles, the coating can be formed by using an adhesive agent. The porous material can be also formed by applying a silver compound such as silver nitrate on the metal substrate and by reducing the silver compound.

The sintering can be conducted, after paste containing the silver particles is applied on the metal substrate, by heating the substrate in a muffle furnace or the like at a temperature about 250 to 450° C. In case of the sintering using the porous silver particles, an additive is unnecessary. When a material is used which makes a dense silver coating after the sintering by itself, a bubbling agent or an extender evaporating or scattering during the sintering is added. A binder can be used for strengthening the bonds among the particles in the porous material.

A material which does not prevent the electric current or can be scattered and removed by the heating is desirably selected as the adhesive agent. The solution application is conducted similarly to a conventional thermal decomposition process. The porous material is formed with adding bubbling agent to a starting material solution, in order to avoid the formation of the dense layer generated by using the conventional thermal decomposition method.

Thickness of the porous material layer must be determined according to the required elasticity and the strength of the porous element material, and is normally sufficient between 0.001 mm and 0.1 mm both inclusive. Preferable porosity is 60 to 90% and more preferable porosity is 70 to 80%. Even the higher porosity seldom makes the electric conductivity of the porous material insufficient because the conductivity thereof is satisfactory.

Thus, the bipolar plate coated with the porous element is manufactured, and is used for a fuel cell. The bipolar plate coated with the porous material is used in contact with a MEA or a current collector in the fuel cell. Even if MEA or the current collector includes convexo-concave or thickness fluctuation, the porous element deforms to absorb these such that the bipolar plate is in uniform contact with the ion exchange membrane or the current collector on its whole surface to obtain uniform current distribution, thereby manufacturing the fuel cell with higher power generation efficiency.

Then, an embodiment of the third invention will be described. The embodiment is a bipolar plate for a fuel cell which is prepared by forming a porous material of metal powders, especially, nickel powders (porous element nickel) on a metal substrate surface to provide the metal substrate with a resilience (or elasticity), and forming a passivation preventing layer on the porous element surface to enable stable operation under strict conditions. The resilience can attain the uniform current distribution by means of the uniform contact between the metal substrate and MEA or the like upon the deformation of the porous element to absorb the convexo-concave or the thickness fluctuation on the ion exchange membrane or the current collector during the contact of the metal substrate with the ion exchange membrane or the like. Further, non-uniform current and increase of an electric resistance can be prevented when a plurality of unit cells are stacked in series.

The porous material is selected from metals which maintain conductivity and are deformable by pressure. The most preferable metal is nickel, and other metal or metal alloy such as steel, stainless steel and Inconel (commercial name) may be also employed. When an expensive metal is used, use of an elementary substance is not required and the porous element prepared by plating the metal on inexpensive metal particle surfaces may be used.

The porous element made of nickel, steel or stainless steel likely forms a passive oxide on its surface by means of anodic polarization similarly to bulk nickel. Accordingly, in the embodiment, the formation of the non-conductive oxide on the porous element surface to lower the conductivity is prevented by forming a passivity prevention layer on the porous element surface when used in a fuel cell.

The material forming the passivity prevention layer is selected from a spinel type oxide including ferrite, magnetite and maghemite; a perovskite type oxide designated by ABO₃; a certain oxide in a rutile form containing conductive titanium oxide and tin oxide; a platinum-group metal; a platinum-group metal alloy and a platinum-group metal oxide. These may be prepared by application and sintering of corresponding metal particles-containing paste or replacement of a metal atom.

Then, a fabrication example of the bipolar plate for the fuel cell of the present embodiment will be described.

The material of the metal substrate is not especially restricted provided that it is conductive and is processed to the required shape, and iron (steel), nickel, alloys thereof, stainless steel, aluminum, tantalum, niobium, titanium and titanium alloy can be efficiently used. Use of the steel and the stainless steel is preferable because of cost and stability.

Titanium, titanium alloy, stainless steel, tantalum and niobium are referred to as a valve metal. Valve metal has the function of preventing the surface corrosion by forming an oxide insulator on its surface in an oxidative atmosphere such as an anodic polarization. The valve metal cannot perform its function by itself as the bipolar plate for the fuel cell because of its insufficient conductivity though it is chemically stable.

Accordingly, when the metal substrate made of the valve metal is used, a conductive oxide coating is preferably formed on the surface of the metal substrate. Also in the alloys of the iron and the nickel which are to be passivated, a conductive oxide is preferably formed on the surface in advance.

The typical compounds of such conductive oxides include, in addition to the compounds of the third invention, a spinel oxide such as ferrite and part of conductive compounds included in perovskite oxides. Similarly to the third invention, a preferable oxide is titanium oxide.

Mechanical processing of the metal substrate, or its necessity, surface cleansing, thermal treatment and formation of the metal plated layer may be conducted or determined similarly to the third invention.

Then, the porous element is coated on the metal substrate surface on which the metal plated layer is formed or is not formed. Preferable thickness and preferable porosity of the porous element are similar to those of the third invention. When the metallic porous element is formed by the application and the sintering of the paste, the required thickness of the porous element can be adjusted at the time of applying the paste because the applied thickness of the paste is maintained after the sintering, and the uniform application of the paste having the thickness is desirable.

While the porous element is preferably coated on the metal substrate surface by sintering, especially, nickel particles, the coating can be conducted by using a chemically stable binder. Alternatively, a solution of a nickel compound such as nickel nitrate is applied on the metal substrate, and the nickel compound may be reduced to provide the porous material.

The sintering may be desirably conducted by so-called loose sintering. The loose sintering is a method of obtaining a less rigid sintered member or a softer sintered member than that obtained by an ordinary sintering under relatively milder conditions. While the ordinary sintering provides an entire compact body, the loose sintering corresponds to an extremely initial stage of the sintering and the sintering takes place at a contacted surface, or a point sintering. The point sintering is realized relatively easily by using the nickel having a uniform particle size. Upon the point sintering, the pressure for the assembly breaks point sintered sections to enable a whole reaction surface in uniform contact with the metal substrate by means of spring-like behavior.

At first, a small amount of starch acting as a binder for increasing an ability of holding applied paste and for preventing oxidation during the sintering is added to nickel particles such as carbonyl nickel powders having a particle size of generally about several microns followed by mixing with water to prepare paste. The paste is applied to a required part of the metal substrate, generally to the entire surface of the metal substrate. While the amount of the added starch may be determined at the discretion, the substantially same amount as that of the carbonyl nickel powders is preferably used.

When a factor for forming the convexo-concave such as the above-described passage of discharging waste water exists on the metal substrate, the application may be conducted in a manner of painting by using a brush. To a flat surface, the application is conducted by using a paddle or using a method by which uniform application can be performed such as a doctor blade method.

After the metal substrate is dried at room temperature depending on necessity, the sintering is conducted. In case of the nickel, the sintering is conducted by heating at about 400 to 600° C., preferably at around 500° C. for about 15 minutes in hydrogen flow such as a reducing atmosphere of argon gas containing about 10% of hydrogen. When the sintering is conducted at a temperature lower than the above temperature range, the decomposition of the binder such as the starch may be insufficient such that the binder possibly remains in the metal substrate. The sintering may excessively progress over 600° C.

In case of sintering the porous metal particles, no additive is required. On the other hand, in case of sintering a material which is converted into a dense metal coating when sintered by itself, a bubbling agent or an extender evaporating or scattering during the sintering is added.

When an adhesive agent is used, a material is desirably selected which does not hinder the current flowing or is removable by sublimation upon heating. The application of coating solution can be conducted similarly to a conventional thermal decomposition process. However, the dense layer is formed by using the conventional thermal decomposition method without modification so that a bubbling agent is added to a starting material solution for providing the porous element.

Then, a passivation preventing layer is formed on the surface of the porous material thus manufactured. The passivation preventing layer is a stable and electric (electrically)conductive oxide layer, and its material is preferably the same as or similar to that of the porous material. The stable and conductive oxide is formed between the materials of the passivation preventing layer and the porous material. Especially, when the passivation preventing layer is formed by the sintering, the materials of the passivation preventing layer and the porous element are desirably the same or similar. When the passivation preventing layer is formed by using a metal other than gold, silver, and a noble metal including platinum-group metals, the electrically conductive oxide is desirable for attaining a stable operation. Or nickel, iron, aluminum, valve metals, nickel alloy such as stainless steel or Inconel is stabilized by forming a passivation film on the surface. The passivation film formation reduces the electric conductivity so that a surface layer becoming stabilized against oxidation is formed for suppressing the conductivity reduction.

When the porous element is made of iron, a liquid containing, for example, nickel or iron-nickel is applied on the metal substrate, and when stainless steel, an alcohol solution of organic iron or organic nickel is applied to the metal substrate surface followed by the sintering in air. Thereby, a stable and conductive ferrite layer acting as the passivation preventing layer is formed on the porous material surface.

While iron alkoxide and nickel alkoxide can be preferably used as the organic iron and the organic nickel, other organic metal compounds may be also used. Inorganic compounds of the iron or the nickel are also usable. When, however, chloride of such metals is used, small amount of chlorine is remained after the thermal decomposition and is caused to corrode the metals in the porous material and the passivation preventing layer after a longer period of time so that no chloride is preferably used.

The conductive titanium oxide can be used as the material for passivation preventing layer, and the passivation preventing layer is formed by applying a mixed solution of, for example, tetrabutyl titanate and pentabutyl tantalate on the porous element surface of the metal substrate and thermally decomposing the applied solution for several minutes at about 500° C. in air. The electrically conductive titanium compounds are desirably in the rutile form, and in the rutile form it must be titanium-tantalum composite oxide. Further, the electrically conductive titanium can contain a small amount of ruthenium.

As described before, the platinum-group metals and the stable noble metals such as gold and silver can be used as the passivation preventing layer. In this case, the metal substrate is soaked in a diluted hydrochloric acid solution of the chlorides of the above noble metals at room temperature for several minutes to initiate the exchanging reaction of metal, thereby the passivation preventing layer is formed on the surface of the porous material.

The method for forming the passivation preventing layer is not restricted thereto, and other process can be used for forming another metal or oxide layer on the surface of the porous material provided that the function of protecting the porous material is secured.

Thus, the bipolar plate coated with the porous material of the present embodiment is manufactured and is used for the fuel cell. The porous material of the bipolar plate is used in contact with the MEA or the current collector in the fuel cell. Even if the MEA or the current collector in the fuel cell includes convexo-concave or thickness fluctuation, the porous material deforms and absorbs these, then the bipolar plate becomes in uniform contact with the MEA or the current collector on its whole surface to obtain uniform current distribution, thereby manufacturing the fuel cell with higher power generation efficiency. While the fuel cell is normally and frequently used under such a severe condition of repeating the anodic polarization and the cathodic polarization, the passivation preventing layer formed on the surface of porous material layer protects the underlying porous material to prevent oxiding the porous material into the non-conductive oxide. Accordingly, the excellent conduction is maintained even after the use for a longer period of time, thereby retaining the higher power generation capacity.

[Fourth Invention]

An ordinary concept has existed in a traditional MEA that the mechanical strength of the MEA is responsible for an ion exchange membrane as described earlier. Although the thinning of the ion exchange membrane may be possible, the thinner ion exchange membrane is not actually in commercialized. Further, the specifications of the ion exchange membrane acting as a solid polymer electrolyte is normally given by a manufacturer, and the ion exchange membrane has been recognized not to be obtained by a manufacturing other than that of the manufacturer. In case of the ion exchange membrane introduction of ion exchange groups is required, and the introduction of the ion exchange groups is generally recognized to lower the mechanical strength of the ion exchange membrane. Accordingly, no alternative has been known for maintaining the mechanical strength of the ion exchange membrane over a specified value other than that thickness of the ion exchange membrane is increased or the ion exchange membrane is reinforced by using a reinforcing member.

However, ionic selectivity is unnecessary for the fuel cell and a lower conduction resistance is sufficient under a humid condition. In such the ion exchange membrane for the fuel cell, less problem arises in connection with the ionic selectivity which is heretofore essential so that the selection of the ion exchange membrane can be conducted more flexibly.

The present inventor has reached to the fourth invention based on the above consideration to the ion exchange membrane for the fuel cell.

In the fourth invention, the mechanical strength of MEA is essentially responsible for an electrode to enable of the mechanical strength of an ion exchange membrane. The following effects can be obtained.

(1) Since the electrode is rigid and has the higher mechanical strength, the whole mechanical strength is seldom influenced even in the case of weakened mechanical strength of the ion exchange membrane. In accordance with the fourth invention, the MEA can be installed by using the ion exchange membrane having the lower mechanical strength or the thinner thickness without decreasing the mechanical strength of the whole MEA. The ion exchange membrane having the lower mechanical strength has normally lower electric resistance. Even if the entire electric resistance is reduced by reducing the electric resistance of the ion exchange membrane, the electrode in the MEA suppresses reduction of the mechanical strength, thereby providing the MEA with the lower electric resistance and the non-reduced mechanical strength. As a result, a factor in connection with the reduction of the electric resistance such as the use of the reinforcing member can be excluded.

(2) Increase of an exchanging capacity is required in an ion exchange membrane depending on its use. The bigger exchanging capacity in the ion exchange membrane accompanies the decrease of the mechanical strength in the conventional MEA. However, in the fourth invention, the decrease of the mechanical strength of the ion exchange membrane does not exert a harmful effect on the entire MEA because the mechanical strength is loaded to the electrode.

(3) Since the ion exchange membrane is not deformed during the manufacturing, the MEA can be easily fabricated. Further the rigid electrode protects the ion exchange membrane after assembly to prevent the deformation of the ion exchange membrane. The ion exchange membrane having extremely small thickness with substantially no mechanical strength can be incorporated in this invention.

(4) When rigidity is provided to either of a cathode or an anode and elasticity is provided to the other, the both electrodes are tightly contacted with the ion exchange membrane though the both electrodes are not formed on the surface of the ion exchange membrane. The tight contact enables the electrodes to be in intimate contact with the ion exchange membrane at a substantially uniform pressure. When used as an electrochemical device, the entire electrode surface can be uniformly utilized to lower the substantial current density.

(5) Since fluid ion exchange resin which is a starting material for the ion exchange membrane can be developed on the rigid electrode surface existing in the MEA, the membrane can be fabricated simultaneously with the fabrication of the MEA. This is because the ion exchange membrane having substantially no mechanical strength can be used in the MEA of the fourth invention while the mechanical strength is responsible for the rigid electrode.

(6) The use of the extremely thin ion exchange membrane enables water generated in an oxygen electrode side of a solid polymer electrolyte fuel cell to easily reach to a hydrogen electrode side after penetrating through the ion exchange membrane. Accordingly, moisture supply to the hydrogen electrode that is heretofore required for keeping the wet condition is no longer necessary. As a result, a higher temperature operation can be readily conducted, and sufficiently high voltage can be obtained when current density is increased. When used in electrolysis, electrolytic voltage can be maintained sufficiently low.

The MEA of the fourth invention is hereinafter described in detail.

Any electrode subjected to no substantial deformation under ordinary conditions may be used as the rigid electrode. An electrode prepared by supporting an electrode material on a rigid substrate (which may also act as a current collector) is preferably used as the rigid electrode, and the rigid substrate includes a perforated metal plate, expanded mesh, a porous carbon plate, and a porous plate or an expanded mesh made of iron, nickel titanium, aluminum, stainless steel or an alloy thereof and having a passivation preventing layer on the surface thereof.

The electrode material to be supported is suitably selected depending on the use. For example, the fuel cell is obtained by forming a porous layer also acting as three-dimensional gas passages made of carbon fibers and carbon powders on the surface of a substrate such as a porous carbon plate and a metal substrate, and by directly supporting, on its surface, platinum or platinum alloy or by baking an electrode material prepared by supporting platinum or platinum-ruthenium alloy on graphite particles by use of a binder such as fluorocarbon resin.

The counter electrode may be also a rigid electrode. However, the both electrodes having the rigidity are hardly in uniform contact with each other on its entire surface sandwiching the ion exchange membrane. Accordingly, such an elastic plate having expanded mesh or a louver obtained by rolling a corrosion-resistant metal such as titanium is used as a substrate for the counter electrode. Then, the porous layer also acting as three-dimensional gas passages made of carbon fibers and carbon powders is formed on the substrate surface, and the platinum or the platinum-ruthenium alloy is directly supported on the outer surface thereof, or by fixing the electrode material prepared by supporting the platinum or the platinum-ruthenium alloy on the graphite particles by use of the binder such as the fluorocarbon resin. Of course, the current collector may be made of the material having the elasticity, the metal or the conductive carbon.

In case of electrolysis, protective current can be provided by externally applying an electric field and a variety of electrolytes are present so that the electrode material resistant to the electrolyte may be selected.

When the rigid electrode is used as an anode in the electrolysis, for example, the above-described expanded mesh or perforated plate made of the titanium is used as the current collector, and the electrodes are of course the same as those of the fuel cell, or such a material as sintered titanium wires, for example, biburi fiber (commercial name), sintered by finely cutting titanium fibers is welded on or formed on the surface onto the current collector.

Then, the electrode material such as platinum and iridium is thermally coated on the current collector surface facing to the ion exchange membrane to form one rigid electrode. The counter electrode can be similarly obtained by superposing a porous member prepared by sintering carbon and fluorocarbon resin on the surface of a substrate such as an unrolled plate having expanded mesh and an elastic louver plate. The specifications of the expanded mesh are not specially restricted, but its thickness and material are fixed, for example, considering a required contact-bonding pressure, an atmosphere and electrolysis conditions. When the mesh is used in acid and a current density is about 10 A/dm², the titanium mesh and having desirable plate thickness of about 0.1 to 0.2 mm and desirable apparent thickness of about 0.3 to 0.5 mm is used though the desirable thickness may change depending on the other conditions.

Titanium mesh having plate thickness of about 0.5 mm and apparent thickness of about 4mm is used, and pressure at about 10 kg/cm² is uniformly applied when a pure water system for electrolytically generating ozone in which the mesh is desirably in tight contact with the ion exchange membrane.

These members are basically assembled by superposing the ion exchange membrane on the rigid electrode and further superposing the elastic counter electrode on the surface thereof. Thereby, the ion exchange membrane in contact with the rigid electrode is not at all deformed or hardly deformed so that the ion exchange membrane is sufficient to have a resistance to the contact-bonding pressure, and the possibility of destruction is nearly zero.

Accordingly, such an ion exchange membrane as that having thickness of about 25 microns heretofore hardly applicable to the fuel cells or that having the extremely excellent conductivity with an equivalent exchanging weight of 800 mg which has extremely weak strength can be readily fabricated.

While the ion exchange membrane and the electrodes may be fixed only by the pressure, they can be bonded by thinly applying ion exchange resin liquid therebetween followed by heating.

No or little force is exerted on the ion exchange membrane so that the state of the ion exchange membrane is not concerned, as described before, and the membrane may not be in a membrane form in advance. The membrane is formed on the electrode by applying paste or a solution containing ion exchange resin on the surface of the rigid electrode. The MEA can be fabricated by superposing the counter electrode on the ion exchange membrane followed by the sintering. Since the ion exchange membrane is not treated as a membrane in the fabrication process, an extremely thin membrane having thickness as low as about 10 microns which is heretofore destroyed due to the weight of the ion exchange membrane itself can be formed.

When a catalyst supported on the electrode is a metal such as platinum, the platinum may be plated on the surface of the ion exchange membrane in addition to the electrode to increase an amount of the electrode material. However, the electrode material is desirably supported only on the electrode in order to decrease burden added to the ion exchange membrane.

[Embodiments]

An example of the fuel cell unit having a bipolar plate and MEA of the present invention is described referring to the drawings.

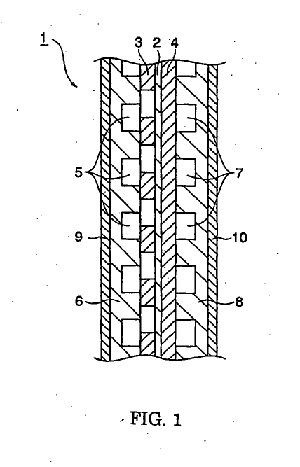

FIG. 1 is a horizontal sectional view exemplifying a fuel cell including a bipolar plate and an MEA of the present invention.

A fuel cell unit 1 includes an anode 3 and a cathode 4 in tight contact with the respective surfaces of an ultra-thin perfluorocarbon sulfonic acid-based ion exchange membrane 2 centrally located. The anode 3 is a rigid electrode made of titanium expanded mesh, and the cathode 4 is an elastic carbon electrode.

A gas passage structure 6 having a passage for cathode gas supply and discharge 5 is mounted on the surface of the anode 3 reverse to the ion exchange membrane 2 such that the passage 5 is directed towards the anode 3. A gas passage structure 8 having a passage for cathode gas supply and discharge 7 is mounted on a surface of the cathode 4 reverse to the ion exchange membrane 2 such that the passage 7 is directed towards the cathode 4.

A cathode side bipolar plate (separator) 9 and an anode side bipolar plate (separator) 10 are mounted on the reverse sides of the both gas passage structures 6,8, respectively, such that the fuel cell unit 1 is separated from an adjacent unit. The bipolar plates are fabricated by forming a metallic coating on a metal substrate and made of a material with excellent durability and a resilience.

The anode 3 in the fuel cell unit 1 is a rigid electrode providing the mechanical strength to the MEA consisting of the anode, the ion exchange membrane and the cathode. The mechanical strength of the MEA is given only for the anode 3, and contributions of the ion exchange membrane 2 and the anode 4 are of little importance.

No disadvantage is recognized when the ultra-thin ion exchange membrane 2 does not contribute to improve the mechanical strength of the MEA. Adversely, the ultra-thin ion exchange membrane 2 reduces the electric resistance to take out electricity at a higher power generation efficiency.

### EXAMPLES

Although Examples and Comparative Examples relating to the bipolar plates for a fuel cell and MEA of the present invention are described, the present invention shall not be restricted thereby. Examples 1 to 2 and Comparative Example 1 relate to the first invention, Examples 3 to 5 and Comparative Example 2 relate to the second invention, Examples 6 to 12 and Comparative Examples 3 to 4 relate to the third invention, and Examples 13 to 16 and Comparative Example 5 relate to the fourth invention.

### Example 1

A SUS 316L plate having an electrode area for a cell of 10 cm×10 cm, thickness of 0.5 mm, and a flange having width of 3 cm including bolt holes and passages for liquid and gas was used as a metal substrate. This bipolar plate was processed for partition and current supply, and the surface thereof was subjected to a blast-treatment with grass beads. Then, the plate was pickled in 20% hydrochloric acid at 80° C.-for 10 minutes, thereby activating the surface by the stainless steel elution of corresponding to thickness of about 0.05 mm.

After the metal substrate was dried, a platinum-group metal oxide was coated on the surface thereof as follows.

Chloplatinic acid and chlororuthenic acid were dissolved in 20% hydrochloric acid to provide a dipping solution such that the respective metals were contained in at 50 g/liter in the solution.

After the metal substrate was dipped in the dipping solution for 10 minutes at room temperature, the surface of the metal substrate turned to pale gray. After the metal substrate was taken off from the dipping solution and washed and dried, the X-ray fluorescence spectroscopic analysis was conducted on the metal substrate with the result that the precipitation of the platinum and the ruthenium both having an amount of 1 g/m² was observed on the metal substrate surface.

After the metal substrate was introduced into a muffle furnace and heated at 600° C. for 2 hours under air flow, it was allowed to stand for cooling in the furnace. The weight of the metal substrate taken from the furnace was slightly increased, and the surface thereof turned to pale black. X-ray diffraction analysis was conducted on the metal substrate with the result that in addition to the diffraction peaks of the stainless steel, the existence of the platinum metal and a rutile type oxide in the was observed. These data revealed that the surface of the metal substrate contained the ruthenium oxide and the platinum.

A membrane-electrode was fabricated by supporting cathode catalyst and anode catalyst on both surfaces of an ion exchange membrane acting as a solid polymer electrolyte. After a carbon plate having trenches acting as gas passages and a current collector was mounted on the assembly to provide a fuel cell unit, 20 pieces of the fuel cell units were connected in series by using the bipolar plate to constitute an oxygen-hydrogen fuel cell. Voltage was 12.5 to 13 V when current of 100 A was flown.

A continuous operation was conducted for 1000 hours while ON/OFF control was repeated every 2 hours. The fuel cell was disassembled after the stop of the operation and received no change with respect to color tone or the like on the bipolar plate. The electric resistance was measured between the both surfaces of the bipolar was the same as that before the use.

### Comparative Example 1

Current was supplied in accordance with the same conditions as those of Example 1 by using the same metal substrate as that of Example 1 except that no conductive oxide coating was formed. While initial voltage was the same as that of Example 1, voltage after 1000 hours was about 0.6 V lower than that of Example 1.

### Example 2

The bipolar plate having the same shape before the processing as that of Example 1 was fabricated by using the SUS 316L plate as the metal substrate. Then, the metal substrate surface was subjected to the blast-treatment in accordance with the same conditions as those of Example 1. Then, the metal plate was acid-washed in a mixed acid solution consisting of 2% hydrofluoric acid and 2% nitric acid for 5 minutes. The metal substrate after the washing and drying was dipped at room temperature for 15 minutes in a dipping solution containing 50 g/liter of ruthenium which was prepared by dissolving ruthenium chloride into 25% hydrochloric acid. Thereby, about 4 g/m² of the ruthenium was precipitated on the metal substrate surface such that the surface was turned to black.

After the metal substrate was thermally oxidized similarly to Example 1, the X-ray diffraction analysis was conducted on the metal substrate with the result that the existence of the stainless steel and the ruthenium oxide was confirmed and the coating was oxidized into the ruthenium oxide.

After a fuel cell was assembled by using the metal substrate as a bipolar plate similarly to Example 1, power generation was conducted by using the fuel cell. Even after 1000 hours of operation, the power generation voltage was unchanged and the bipolar plate was also unchanged.

### Example 3

A titanium plate having an electrode area for a cell of 10 cm×10 cm, thickness of 0.5 mm, and a flange having width of 3 cm including bolt holes and passages for liquid and gas was used as a bipolar plate for a solid polymer electrolyte fuel cell. This bipolar plate was processed for separator and current supply, and the surface thereof was blasted with grass beads. Then, the plate was pickled in 20% hydrochloric acid at 95° C. for 20 minutes, thereby activating the surface before the titanium corresponding to thickness of about 0.05 mm was eluted.

After the metal substrate thus treated was dried, it was heated for 1 hour at 550° C. in air flow.

A conductive oxide coating (titanium oxide coating) was formed on the metal substrate surface as follows.

A hydrochloric acid solution of titanium tetrachloride was mixed with a mixed solvent containing 20% hydrochloric acid and n-propyl alcohol in a weight ratio of 1:1. To the mixed solvent, 10 molar % of ruthenium chloride with respect to the titanium chloride was added such that a titanium-ruthenium coating solution having titanium concentration of 50 g/liter was prepared.

After the coating solution was applied to the both surfaces of the metal substrate and dried, the metal substrate was heated for 10 minutes at 500° C. The solution application-heating was repeated three times to provide a bipolar plate for a fuel cell. The coating color obtained was black.

The status of the coating layer of the obtained oxide coated on the metal substrate was investigated by an X-ray diffraction with the result that titanium oxide in a rutile form was formed.

A Membrane Electrode Assembly was fabricated with loading cathode catalyst and anode catalyst on both surfaces of an ion exchange membrane as a solid polymer electrolyte. Carbon plates having trenches for gas passages as current collector were mounted on the assembly to provide a fuel cell unit, 100 pieces of the fuel cell units were connected in series by using the bipolar plate to constitute an oxygen-hydrogen fuel cell. Generated cell voltage was 62 to 65 V when the current load was 100 A.

A continuous operation was performed for 1000 hours while ON/OFF control was repeated every 2 hours. The fuel cell was disassembled after the stop of the operation and received no change with respect to color or the like. The electric resistance measured between the both surfaces of the bipolar plate gave the same as that before the use.

### Example 4

A fuel cell was assembled by using a bipolar plate fabricated under the same conditions as those of Example 3 except that the ruthenium chloride was not added to the coating solution. The coating of the conductive titanium oxide was pale yellow. Only anatase phase was observed on the coating by X-ray diffraction.

The electric resistance between the both surfaces of the bipolar plate was measured to be slightly higher than that of Example 1. Voltage was 62 to 65 V when the current was 100 A.

A voltage drop of about 5V after the 1000 hour continuous operation was observed.

### Example 5

The bipolar plate having the same size and shape before the processing as that of Example 3 was fabricated by using the SUS 316L plate as the metal substrate. Then, the metal substrate surface was blasted in accordance with the same conditions as those of Example 3. Then, the metal plate was pickled in a mixed acid solution consisting of 2% hydrofluoric acid and 2% nitric acid for 5 minutes. The metal substrate after the washing and drying was annealed in a muffle furnace at 600° C. for 3 hours for surface oxidation.

Coating solution was prepared by mixing tetrabutyl orthotitanate, 20 molar % of pentabutyl tantalate with respect to the titanium in the tetrabutyl orthotitanate, and with adding diluted hydrochloric acid to adjust pH to be 2 and by further adding n-propyl alcohol.

After the coating solution was applied on the oxidized metal substrate surface followed by drying, the metal substrate was heated in a muffle furnace at 550° C. for 15 minutes for thermal decomposition. The solution application to thermal decomposition was repeated four times to provide a conductive oxide coating.

The conductive oxide coating was observed with an X-ray diffraction (XRD) with the results that the oxide coating and found a rutile type crystalline though the crystallinity thereof was inferior to the conductive oxide coating of Example 3.

The metal substrate having the conductive oxide coating is generally used as the bipolar plate for the fuel cell. In this Example, the metal substrate was used as a cathode in a 2% caustic soda aqueous solution, and electrolysis was conducted while electric current was between the cathode and an anode at a current density of 10 A/dm². Even after the 100 hour electrolysis, the voltage increase was not at all recognized and the electrolysis could be continued without modification. That is, it was conjectured that no insulative oxide was formed so that the metal substrate could be effectively used as the bipolar plate for the fuel cell.

### Comparative Example 2

Current was supplied in accordance with the same conditions as those of Example 5 by using the same metal substrate as that of Example 5 except that no conductive oxide coating was formed. Voltage increase became conspicuous after about 30 hours, and initial voltage of 3.2 V turned to 5 V or more after 100 hours, and a passive oxide was formed on the surface.

### Example 6

After a stainless steel plate having thickness of 0.2 mm was processed to a bipolar plate or a metal substrate having trenches on the surface formed by pressing, the metal substrate was pickled in 20% boiled hydrochloric acid for 3 minutes for surface activation. Then, the surface thereof was silver-plated in a cyanide plating bath containing silver with the silver thickness of about 1 micron.

Spherical silver particles having an average particle diameter of 1 micron was mixed with a small amount of gum xanthan bubbling and deionized water to which a detergent acting as a blowing agent was added to provide paste having a plenty of bubbles therein. The paste was applied on the electrode section of the silver-plated substrate while the paste was spread. The applied thickness was adjusted to be about 0.1 mm by a doctor blade process.

After drying at room temperature for 1 hour, the metal substrate was heated at 80° C. for removing residual moisture. Then, the substrate was dried nearly completely in an oven at 180° C., and finally heated for sintering in a muffle furnace at 350° C. for 1 hour. In this manner, a bipolar plate having porous silver coating with apparent thickness slightly below 0.1 mm on its surface was obtained. An electrode area was about 100 cm² and an apparent packing rate of the porous silver was 20 to 25%.

In order to clarify a thickness change of the bipolar plate, a partial concave on the coated silver layer created by applying a pressure on the surface of the bipolar plate was observed. The thickness was reduced by 30 microns (0.03 mm) at a pressure of 49 Pa (5 barometric pressure), and by 45 microns at a pressure of 98 Pa (10 barometric pressure). The subsequent pressure release returned the thickness by about 20%. The bipolar plate was clarified to have a certain degree of the resilience, though not perfect, and to retain relatively uniform adhesiveness.

### Example 7

After 0.2 mm thick of mild steel plate was processed to the same as that of Example 6 by pressing, the surface of this metal substrate was pickled in 20% hydrochloric acid at 60° C. for cleaning and activation. After a hydrazine aqueous solution acting as a reducing agent was applied on the substrate surface in advance followed by drying, a silver nitrate aqueous solution was applied and dried. Then, the hydrazine aqueous solution was applied dropwise onto the surface to precipitate the silver. A silver plated layer having metallic luster was formed on the steel plate surface by repeating the above procedure three times.

After silver particles having an average particle size of 2 microns was added and sufficiently mixed with dextrin powders having an amount four times that of the silver particles in weight, water was added thereto and mixed to provide silver paste. After the paste was applied with a paddle on the surface of the substrate on which the silver-plated layer was formed such that thickness was adjusted to be about 100 microns, the thickness of the paste on the substrate surface was made uniform by using a roller. Then, the substrate was retained at room temperature for 1 hour and dried at 110° C. for 15 minutes.

At first, the substrate was heated in a muffle furnace in ambient atmosphere at 250° C. for conducting first sintering. Thereby, a black coating was obtained due to incomplete decomposition of the dextrin. Then, the temperature of the muffle furnace was elevated to 400° C. for conducting second sintering to provide a bipolar plate coated with porous silver having apparent thickness of about 100 microns. An electrode area was about 100 cm² and an apparent packing rate of the porous silver was 20 to 25%.

Similarly to Example 6, the deformation of the coated layer due to a pressure was measured. The thickness was reduced by microns (0.025 mm) at a pressure of 49 Pa (5 barometric pressure), and by 35 microns at a pressure of 98 Pa (10 barometric pressure). The subsequent pressure release restored the thickness by about 15%. The bipolar plate was clarified to have a certain degree of the resilience and to retain relatively uniform adhesiveness.

### Example 8

0.2 mm thick titanium plate was shaped by pressing the same as that of Example 6. The surface of this titanium substrate was pickled in oxalic acid to form fine convexo-concaves on the surface. The metal substrate was soaked and electroplating was carried out in a plating bath including the Watt bath for nickel plating where pH was adjusted to be 3.5 to 4, and current was provided at a current density of 5 A/dm² and the temperature was 40° C. About 0.8 micron Ni-plated layer was obtained on the metal substrate surface. Further, a silver-plated layer was formed on the surface of the nickel-plated layer of the substrate similarly to Example 6.

A porous silver coating was formed on the metal substrate surface in accordance with the same conditions as those of Example 6 except that a sintering temperature was 300° C.

Similarly to Example 6, the deformation (partial concave) of the coated layer due to a pressure was measured. The thickness was reduced by 25 microns (0.025 mm) at a pressure of 49 Pa (5 barometric pressure), and by 50 microns at a pressure of 98 Pa (10 barometric pressure). The subsequent pressure releases returned the thickness by 25% and 15% in this order. The bipolar plate was clarified to have a certain degree of the resilience and to retain relatively uniform adhesiveness.

### Comparative Example 3

A bipolar plate was fabricated in accordance with the same conditions as those of Example 6 except that the porous silver coating was not formed.

Similarly to Example 6, the deformation of the coated layer due to a pressure was measured. The thickness of the bipolar plates was unchanged at a pressure of 49 Pa (5 barometric pressure) and at a pressure of 98 Pa (10 barometric pressure).

### Example 9

A bipolar plate was fabricated in accordance with the same conditions as those of Example 6 except that the stainless steel plate was replaced with a carbon plate.

Similarly to Example 6, the deformation (partial concave) of the coated layer due to a pressure was measured. The thickness was reduced by about 30 microns (0.03 mm) at a pressure of 49 Pa (5 barometric pressure), and by about 35 microns at a pressure of 98 Pa (10 barometric pressure). The subsequent pressure releases restored the thickness by 20% and 10% in this order. The bipolar plate was clarified to have a certain degree of the resilience and to retain relatively uniform adhesiveness.

### Example 10

After a metal substrate of 0.2 mm thick stainless steel plate was processed to a bipolar plate having trenches on the surface formed by pressing, the metal substrate was acid-washed in 20% boiled hydrochloric acid for 3 minutes for surface activation.

Reagent-level carbonyl nickel powders, about 10% in weight of xanthan gum with respect to the carbonyl nickel powders and a neutral detergent acting as a bubbling agent were added to deionized water under stirring to prepare paste having bubbles therein. The paste was applied onto the electrode section of the metal substrate while the paste was spread. The applied thickness was adjusted to be about 0.1 mm in accordance with a doctor blade process.

After drying at room temperature for 1 hour, the metal substrate was heated at 80° C. for removing residual moisture. Then, the substrate was dried nearly completely in an oven at 180° C., and finally heated for sintering in a muffle furnace under mixed gas flow consisting of hydrogen:argon=1:1 (volume ratio) at 450° C. for 15 minutes. In this manner, a metal substrate having porous nickel coating with apparent thickness slightly below 0.1 mm on its surface was obtained. An electrode area was about 100 cm² and an apparent packing rate of the porous nickel was 20 to 25%.

Coating solution was prepared by adding, to an iron nitrate aqueous solution having iron concentration of 50 g/liter, 10% in volume of n-propyl alcohol with respect to the iron nitrate aqueous solution.

The coating solution was applied on the metal substrate surface having the porous nickel coating thereon and heated at 350° C. in dry air. After the procedure was repeated twice, formation of a black oxide (passivation preventing layer) was formed on the metal substrate surface.

In order to clarify a thickness change of the bipolar plate thus obtained, a partial concave on the coated silver layer created by applying a pressure on the surface of the bipolar plate was observed. The thickness was reduced by 25 microns (0.025 mm) at a pressure of 49 Pa (5 barometric pressure), and by 35 microns at a pressure of 98 Pa (10 barometric pressure). The subsequent pressure release returned the thickness by about 20%. The bipolar plate was clarified to have a certain degree of the resilience, though not perfect, and to retain relatively uniform adhesiveness.

Then, the following procedure was conducted for confirming the effect of preventing the passivity by the black oxide. The surface of the metal substrate other than the porous nickel coating section and the passivity prevention layer was sealed with a polytetrafluoroethylene tape. The metal substrate was dipped with anodic polarization in a sodium sulfate aqueous solution having pH=2.5 and was allowed to stand for 2 hours in air flow while voltage of 1.24 (vs. NHE, theoretical decomposition voltage of water) was applied and a platinum wire was used as a counter electrode. However, current was hardly observed.

A platinum foil was attached on the metal substrate surface to constitute an anode. The anode together with a platinum plate having the same shape and acting as a counter electrode was dipped in an electrolytic cell such that the distance between the electrodes was 30 mm. Electrolysis was conducted by supplying current such that a current density was adjusted to be 10 A/dm² at room temperature, and cell voltage was measured. The current was supplied through the bipolar plate coated with the porous nickel. The measured voltage was 2.5 to 3 V showing that the stable electrolysis could be operated.

### Comparative Example 4

A bipolar plate was fabricated in accordance with the same conditions as those of Example 10 except that the black oxide was not formed.

Similarly to Example 10, the metal substrate adhered with the platinum foil at the same pressure was dipped in a sodium sulfate aqueous solution having pH=2.5 and was allowed to stand for 2 hours in air flow while voltage of 1.24 V (vs. NHE) was applied and a platinum wire was used as a counter electrode. At the initial stage of the current supply, no vivid bubble generation was observed though a slight amount of the current was flown. Thereafter, no current was flown. The slight amount of the current was supposed due to surface oxidation.

Then, current was supplied in accordance with the same conditions as those of Example 10 by using the bipolar plate. However, no current was flown, and when the voltage was elevated to 10 V, a current density was elevated as low as about 1A/dm².

The difference between Example 10 and Comparative Example 4 was only the existence or no existence of the passivation preventing layer. While the sufficient current was given in the bipolar plate having the passivity prevention layer in Example 10, the sufficient current was not obtained in the bipolar plate having no passivation preventing layer in Comparative Example 4, thereby proving that the passivity prevention layer in Example 10 efficiently operated.

### Example 11

After a 0.2 mm thick mild steel plate was shaped by pressing the same as that of Example 10, the surface of this metal substrate was pickled in 20% hydrochloric acid at 60° C. for cleaning and activation. After nickel was plated on the substrate surface with 3 microns, a porous nickel coating was formed in accordance with the same conditions as those of Example 10.

An coating solution prepared by dissolving TiCl₄ and H₂RuCl₄ in a metal weight ratio of 9:1 into butyl alcohol was applied on the metal substrate surface and dried. The metal substrate was baked in a muffle furnace at 450° C. The procedure of the application, the drying and the baking was repeated three times to form a black titanium oxide-ruthenium oxide surface layer (passivation preventing layer).

In order to clarify a thickness change of the bipolar plate, a partial concave on the coated silver layer created by applying a pressure on the surface of the bipolar plate was observed similarly to Example 10. The thickness was reduced by 25 microns (0.025 mm) at a pressure of 49 Pa (5 barometric pressure), and by 35 microns at a pressure of 98 Pa (10 barometric pressure). The subsequent pressure release returned the thickness by about 10%. The bipolar plate was clarified to have a certain degree of the resilience (recovering force), though not perfect, and to return relatively uniform adhesiveness.

Similarly to Example 10, whether the passivation preventing layer was electrolytically formed or not was observed. The measured voltage was 2.5 to 3 V showing that the stable electrolysis could be operated.

### Example 12

After a nickel plate having thickness of 0.2 mm was shaped in accordance with the procedure the same as that of Example 10, the surface of the metal substrate was acid-washed in oxalic acid to make fine convexo-concaves on the surface thereof, and further a porous nickel coating was formed on its surface similarly to Example 10.

The metal substrate was dipped at room temperature for 3 minutes in a solution prepared by dissolving chlororuthenic acid and chloplatinic acid in a weight ratio of (ruthenium):(platinum)=5:1 in a 10% hydrochloric acid aqueous solution to form a black alloy layer made of the ruthenium and the platinum on the porous nickel coating by means of a substitution reaction occurring on the surface of the porous nickel coating, thereby providing a bipolar plate. An amount of the alloy in the alloy layer was about 1 to 2 g/m², and the alloy layer was actually grayish black.

The resilience of the bipolar plate was measured in accordance with the same conditions as those of Example 10. The thickness was reduced by 25 microns (0.025 mm) at a pressure of 49 Pa (5 barometric pressure), and by 35 microns at a pressure of 98 Pa (10 barometric pressure). The subsequent pressure release restored the thickness by about 10 to 15%.

Similarly to Example 10, whether the passivity prevention layer was electrolytically formed or not was observed. The measured voltage was stable around about 2.7 V.

### Example 13

Titanium expanded mesh having pore ratio of 60% and the plate thickness of 0.3 mm and apparent plate thickness of 1 mm acting as a current collector was plated with silver by 1 micron thickness. Carbon cloths made of graphite fibers were superposed on both surfaces of the current collector. Carbon black (Denka Black available from Denki Kagaku Kogyo K.K.) was filled in the spaces between the respective carbon cloths and the respective surfaces of the current collectors by using PTFE acting as a binder, thereby providing a porous and flat substrate.

PTFE liquid (30 E available from Du Pont) having a solid content of about 5% in weight was applied on one surface of the flat substrate for providing hydrophobicity. A co-precipitation mixture containing platinum and ruthenium was sintered and supported on the surface of graphite particles having an average particle size of 5 microns acting as an electrode material by using, as a binder, Nafion liquid available from Du Pont including perfluorocarbon sulfonic acid based-ion exchange resin, thereby providing catalyst-supported particles. The particles were baked on the reverse surface of the flat substrate by also using the Nafion liquid as a binder, thereby providing a rigid electrode.

Then, graphite particles supported with platinum black was baked on the surface of a carbon cloth made of graphite fibers available from Toho Rayon Co., Ltd. by using Nafion as a binder, thereby providing a counter electrode.

Nafion 110 acting as a cation exchange membrane available from Du Pont was sandwiched between the two electrodes and sintered under heating at 130° C. and at a pressure of 3 kg/cm², thereby providing an MEA. No deformation was observed when the MEA was dipped in water. Neither fracture nor deformation was observed when the MEA sheet having width of 5 cm was subjected to a tension test with a load of 10 kg.

### Comparative Example 5

Platinum-supported carbon black and carbon black supporting alloy consisting of platinum and ruthenium in a ratio of 1:1 were baked on the respective surfaces of the ion exchange membrane of Example 13 to prepare an MEA having a flat substrate and a counter electrode, respectively, with other conditions the same as those of Example 13. When the MEA was dipped in water, swelling due to the water was observed, and fracture was observed at a load of about 0.5 kg.

### Example 14

Paste was prepared by adding isopropyl alcohol to carbon black (Denka Black available from Denki Kagaku Kogyo K.K.), PTFE liquid available from Du Pont (30 E) and a neutral detergent (“Emaru”, available from Kao Corporation) acting as a surface active agent followed by mixing. After the paste was applied to a carbon cloth made of graphite available from Toho Rayon Co., Ltd, the carbon cloth was preheated at 150° C. and further sintered at 240° C., thereby providing an electrode substrate having surface water repellency and rigidity.

Platinum black powders precipitated by adding aqueous ammonia to a chloroplatinic acid aqueous solution was applied on one surface of the electrode substrate by using Nafion liquid as a binder and heated at 130° C., thereby supporting the platinum black as catalyst. After the Nafion liquid was further applied on the catalyst surface followed by drying, the electrode substrate was heated at 120° C. to form a thin ion exchange layer.

The thin ion exchange layers of a pair of the electrode substrates opposed to each other were affixed by using Nafion liquid as a binder and baked in a hot-pressing apparatus at a temperature of 130° C. and a pressure of 3 kg/cm² for 30 minutes, thereby providing an MEA formed by the two electrode substrates sandwiching an ion exchange membrane therebetween.

The MEA was assembled in a fuel cell which was initially kept wet. Then, while hydrogen in a hydrogen cylinder without being humidified was supplied to a fuel electrode, oxygen on an oxygen cylinder was supplied to the counter electrode without modification. At a temperature of 90° C., stable voltage of 0.73 V was obtained at a current density of 1 A/cm² so that the MEA was confirmed to operate for the fuel cell. Further, the fuel cell was confirmed to operate in a dry condition because the membrane was thin.

### Example 15

After titanium powders acting as a binder and having an average particle size of 10 microns and starch powders having a volume one-tenth that of the titanium powders were mixed with water, the mixture was molded to a plate having thickness of 2 mm and dried. The molded component was sintered at 900° C. in a vacuum furnace to fabricate a porous titanium plate acting as an electrode substrate. Then, the electrode substrate was oxidized under heating at 600° C. in air for 1 hour. Thereby, a blue conductive titanium oxide layer was formed on the surface, and the surface was made hydrophilic.

A dinitrodiammine platinum liquid having dispersed submicron fine particles prepared by thermally decomposing iridium chloride in air at 400° C. was applied on one surface of the electrode substrate and baked at 300° C. This procedure was repeated three times to provide an electrode made of the platinum having an amount of 5 g-platinum/m² and the iridium oxide having an amount of 10 g-iridium/m². Nafion liquid available from Du Pont was applied on the electrode surface and heated at 120° C. to form a Nafion layer.

A plate was fabricated by sintering carbon black by using PTFE as a binder. Isopropyl alcohol solution of chloroplatinic acid was applied on the surface thereof and thermally decomposed at 300° C. to support platinum on the surface, thereby providing a counter electrode. The application and the baking were repeated five times to give the loading amount of the platinum to 10 g/m². The Nafion liquid was similarly applied to the platinum side surface of the counter electrode and heated at 120° C.

The electrode and the counter electrode made of the carbon were positioned such that the Nafion surfaces thereof were opposed to each other. After Nafion liquid was again applied on the Nafion surfaces, the both electrodes were baked at 130° C. and bonded at a pressure of 3 kg/cm², thereby providing an MEA.

The MEA superposed on a current collector having water passages on the both surfaces thereof was fastened at a pressure of 10 kg/cm² to be incorporated in a cell for electrolyzing water. Electrolysis was conducted by using the titanium side of the MEA as an anode while water was supplied only from the titanium side. The electrolysis could be continued at a current density of 1 A/cm² and electrolysis voltage of 1.65 V.

### Example 16

Electrolysis was conducted in accordance with the same conditions as those of Example 15 except that, in place of the formation of the ion exchange membrane by the application and the baking of the Nafion liquid, a commercially available cation exchange membrane (Nafion 110 available from Du Pont) was used as a solid polymer electrolyte. Electrolysis voltage was 1.75 to 1.8 V The difference between the electrolysis voltage of Example 15 and Example 16 was probably due to the difference of electric resistances of the both ion exchange membranes.

Since the above embodiments are described only for examples, the present invention shall not be restricted to the above embodiments, and various modifications or alternations can be easily made therefrom by those skilled in the art without departing from the scope of the present invention.

1. A bipolar plate for a fuel cell comprising a metal substrate made of one or more metals or metal alloys selected from a group consisting of iron, nickel, alloys thereof and stainless steel; and a metallic coating including a conductive platinum-group metal oxide, formed on at least part of a surface of the metal substrate.

2. The bipolar plate for the fuel cell according to claim 1, wherein the metallic coating further includes platinum.

3. The bipolar plate for the fuel cell according to claim 1, wherein part of the metal substrate is exposed, and the exposed surface of the metal substrate is oxidized.

4. A method for manufacturing a bipolar plate for a fuel cell including a metallic coating formed on at least part of a metal substrate comprising the steps of:
applying a solution containing a platinum-group metal compound on the metal substrate made of one or more metals or metal alloys selected from a group consisting of iron, nickel, alloys thereof and stainless steel;
replacing at least part of metal atoms on the metal substrate with platinum-group metal atoms in the platinum-group metal compound; and
treating the metal substrate in an oxidizing atmosphere, thereby oxidizing at least part of the metal and the replaced platinum-group metal on the metal substrate surface.

5. A method for fabricating a bipolar plate for a fuel cell including a metallic coating formed on at least part of a metal substrate comprising the steps of:
applying a solution containing a platinum-group metal compound on the metal substrate made of one or more metals or metal alloys selected from a group consisting of iron, nickel, alloys thereof and stainless steel;
thermally decomposing at least part of a metal on the metal substrate surface to convert the metal into its oxide, thereby forming a conductive platinum-group metal oxide coating on the metal substrate surface.

6. A bipolar plate for a fuel cell comprising a thermally oxidized metal substrate and a metallic coating made of a conductive oxide formed on at least part of a surface of the metal substrate.

7. The bipolar plate for the fuel cell as claimed in claim 6, wherein the metal substrate is made of one or more metals or metal alloys selected from a group consisting of titanium, tantalum, niobium, alloys thereof and stainless steel.

8. The bipolar plate for the fuel cell as claimed in claim 6, wherein the conductive oxide coating is a conductive titanium oxide coating which is formed by applying, on the metal substrate, a titanium oxide precursor prepared by adding a ruthenium compound and/or an iridium compound to titanium oxide in a rutile form followed by thermal decomposition.

9. The bipolar plate for the fuel cell as claimed in claim 6, wherein the conductive oxide coating is a conductive titanium oxide coating which is formed by applying, on the metal substrate, a titanium oxide precursor prepared by adding a tantalum compound to titanium oxide in a rutile form followed by thermal decomposition.

10. A method for fabricating a bipolar plate for a fuel cell including a metallic coating formed on at least part of a metal substrate comprising the steps of:
thermally oxidizing the metal substrate made of one or more metals or metal alloys selected from a group consisting of titanium, tantalum, niobium, alloys thereof and stainless steel at a temperature of 450 to 700° C. to convert at least part a surface of the metal substrate into an oxide thereof;
applying a conductive oxide precursor on the surface of the metal substrate; and
thermally decomposing the conductive oxide precursor, thereby forming a conductive oxide coating.

11. A bipolar plate for a fuel cell comprising a metal or carbon substrate and a metallic coating including a metallic porous element and formed on at least part of the metal or carbon substrate.

12. The bipolar plate for the fuel cell as claimed in claim 11, wherein the metallic porous element includes a silver porous element.

13. The bipolar plate for the fuel cell as claimed in claim 12 further comprising a silver plated layer between the metal or carbon substrate and the silver porous element.

14. The bipolar plate for the fuel cell as claimed in claim 11, wherein the metal substrate is made of one or more metals or metal alloys selected from a group consisting of aluminum, iron, nickel, alloys thereof, stainless steel, titanium and titanium alloy.

15. The bipolar plate for the fuel cell as claimed in claim 11, wherein the metallic porous element is prepared by application and sintering of metal-containing paste, coating of the metallic porous element by means of using a bonding agent and/or thermal decomposition by means of using a blowing agent.

16. A bipolar plate for a fuel cell comprising a carbon-based substrate and a metallic porous element formed on a surface of the carbon-based substrate.

17. The bipolar plate for the fuel cell as claimed in claim 11 further comprising a passivity prevention layer on a surface of the metallic porous element.

18. The bipolar plate for the fuel cell as claimed in claim 17, wherein the metallic porous element is made of nickel or a nickel alloy.

19. The bipolar plate for the fuel cell as claimed in claim 17, wherein the metallic porous element is prepared by sintering a corresponding carbonyl metal in hydrogen flow.

20. The bipolar plate for the fuel cell as claimed in claim 17, wherein the metallic porous element is formed by using loose sintering.

21. The bipolar plate for the fuel cell as claimed in claim 17, wherein a material forming the passivity prevention layer is selected from a group consisting of a spinel oxide including ferrite, magnetite and maghemite; a perovskite oxide designated by ABO₃; a certain oxide in a rutile form containing conductive titanium oxide and tin oxide; a platinum-group metal; a platinum-group metal alloy and a platinum-group metal oxide.

22. A method for fabricating a bipolar plate for a fuel cell comprising the steps of:
forming a metallic porous element on a surface of a metal substrate; and
applying metal-containing paste for forming a passivity prevention layer on a surface of the metallic porous element; and
sintering the paste, thereby forming the passivity prevention layer on the surface of the metallic porous element.

23. The method for fabricating the bipolar plate for the fuel cell as claimed in claim 22, wherein the metallic porous element is formed by using loose sintering.

24. A method for fabricating a bipolar plate for a fuel cell comprising the steps of:
forming a metallic porous element on a surface of a metal substrate; and
forming a passivity prevention layer on a surface of the metallic porous element by means of replacement of the metallic porous element with a platinum-group metal or its alloy.

25. The method for fabricating the bipolar plate for the fuel cell as claimed in claim 24, wherein the metallic porous element is formed by using loose sintering.

26. An membrane-electrode assembly comprising an ion exchange membrane, a cathode and an anode tightly attached to the ion exchange membrane, at least one of the cathode and the anode having rigidity.

27. The membrane-electrode assembly cell as claimed in claim 26, wherein one of the cathode and the anode has the rigidity and the other has elasticity.

28. The membrane-electrode assembly cell as claimed in claim 26, wherein the ion exchange membrane contains no reinforcing element.

29. A method for fabricating membrane-electrode assembly comprising the steps of:
developing fluid ion exchange resin acting as a starting material for an ion exchange membrane on a surface of a rigid electrode;
sandwiching the ion exchange resin between the rigid electrode and a counter electrode; and
solidifying the ion exchange resin to convert into the ion exchange membrane.

30. A fuel cell comprising an electrode-ion exchange membrane assembly in which an cathode and an anode are tightly attached to the ion exchange membrane, and at least one of the cathode and the anode is rigid.

31. A zero-gap electrolyzer comprising an electrode-ion exchange membrane assembly in which an cathode and an anode are tightly attached to the ion exchange membrane, and at least one of the cathode and the anode is rigid.
